(19) United States
(12) Patent Application Publication
(10) Pub. No.: US 2024/0297888 A1
(43) Pub. Date: Sep. 5, 2024

(54) SYSTEM AND METHOD TO VERIFY TRUSTWORTHINESS OF AN IHS USING SYSTEM TIME

(71) Applicant: Dell Products, L.P., Round Rock, TX (US)

(72) Inventors: Shinose Abdul Rahiman, Bangalore (IN); Rama Rao Bisa, Bangalore (IN); Dharma Bhushan Ramaiah, Bangalore (IN); Vineeth Radhakrishnan, Palakkad (IN); Mini Thottunkal Thankappan, Bangalore (IN)

(73) Assignee: Dell Products, L.P., Round Rock, TX (US)

(21) Appl. No.: 18/177,155

(22) Filed: Mar. 2, 2023

(51) Int. Cl. H04L 9/40

(52) U.S. Cl. CPC H04L 63/123; H04L 63/0823

(57) ABSTRACT

According to embodiments of the present disclosure, a system time verification system and method provided using Security Protocol and Data Model (SPDM)-enabled Baseboard Management Controller (BMC). The system time verification system and method include program instructions that may be executed on a BMC to obtain a system time value stored in the BMC after being attested by a requester using a device security certificate associated with the BMC, sign the system time value using the device security certificate, and send the signed system time value to the requester.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

Communication networks, and in particular the Internet, has revolutionized the manner in which software is updated on a computer system. Prior to the advent of the Internet, a software provider would package the update on computer readable media, and the computer owner had to obtain a copy of the media to complete the update in order to make the software update accessible to the user of the computer system. However, distributing software updates on computer readable media was often expensive for software providers, which tended to restrict the number of software updates that a software provider would issue. As a consequence, substantial time would pass between updates, and consumers had to manage certain known issues for these time periods, at least until an update became available. Another aspect of this older method was that many modifications were packaged into a single update to reduce the costs associated with distributing the update.

SPDM-based attestation, which has been published by the Platform Management Components Intercommunication (PMCI) Working Group of the Distributed Management Task Force (DMTF), generally involves a security mechanism to remotely detect an adversarial presence on a device to guarantee the device's trustworthiness. Attestation runs as a two-party security scheme in which a trusted party (e.g., the requesting device) assures the integrity of the untrusted remote device (e.g., the responding device). A request, using this scheme, can determine identity of a device and/or the firmware/software that the device is running. The responding device may send proof about its current state using a cryptographic hash to the requesting device. The requesting device may then evaluate the received evidence with the expected legitimate state of the responding device, and validate whether or not the responding device is trustworthy or not. Many system-on-chip (SOC) platforms now use SPDM-based attestation due in large part, to its light weight and high levels of security provided thereby.

### SUMMARY

According to embodiments of the present disclosure, a system time verification system and method provided using Security Protocol and Data Model (SPDM)-enabled Baseboard Management Controller (BMC). The system time verification system and method include program instructions that may be executed on a BMC to obtain a system time value stored in the BMC after being attested by a requester using a device security certificate associated with the BMC, sign the system time value using the device security certificate, and send the signed system time value to the requester.

According to another embodiment, a system time trustworthiness verification method includes the steps of, after being attested by a requester using a device security certificate associated with a Baseboard Management Controller (BMC), obtaining a system time value stored in the BMC, wherein the BMC conforms to a Security Protocol and Data Model (SPDM) specification, signing the system time value using the device security certificate, and sending the signed system time value to the requester.

According to yet another embodiment, a computer program product includes computer-executable instructions to, after being attested by a requester using a device security certificate associated with the BMC, obtain a system time value stored in the BMC, sign the system time value using the device security certificate, and send the signed system time value to the requester.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an Information Handling System (IHS) that may be configured to implement a system and method for collective attestation according to one embodiment of the present disclosure.

FIG. 2 illustrates an example system time trustworthiness verification system according to one embodiment of the present disclosure.

FIG. 3 illustrates an example flow diagram of a system time trustworthiness verification method showing how the time synchronization requester may communicate with the time synchronization responder to continually monitor the system time of the BMC to ensure that its system time is not changed to an invalid value according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer's operating system or BIOS) hardware management tasks. The BMC firmware can support industry-standard Specifications, such as the Intelligent Platform Management Interface (IPMI) and Systems Management Architecture of Server Hardware (SMASH) for computer system administration.

Baseboard management controllers (BMCs) are particularly well suited for the features provided by the Security Protocol and Data Model (SPDM) specification. The SPDM specification has been published by the Platform Management Components Intercommunication (PMCI) Working Group of the Distributed Management Task Force (DMTF). A particular goal of the SPDM specification is to facilitate secure communication among the devices of a platform management subsystem. Examples of a platform management subsystem may include an Information Handling System (IHS), such as a desktop computer, laptop computer, a cellular telephone, a server, and the like.

The SPDM specification defines messages and procedures for secure communication among hardware devices, which includes authentication of hardware devices and session key exchange protocols to provide secure communication among those hardware devices. Management Component Transport Protocol (MCTP) Peripheral Component Interconnect Express (PCIe) vendor defined message (VDM) channels, which supports peer-to-peer messaging (e.g., route by ID), allow a SPDM-enabled hardware device to issue commands to other SPDM-enabled hardware devices within a secure communication channel.

Cyber attackers are reportedly exploiting and abusing devices, such as platform interface protocol analyzers to steal unencrypted information, spy on network traffic, and gather information to leverage in future attacks against platform components and component interfaces (e.g., I2C, PCIe, I3C, Sensewire, SPI, etc.) of an IHS. Detection of vulnerable platform components is not an easy task, and exploiting unpatched vulnerabilities could allow the attacker to take control of the IHS. Some example platform security risks may include compromised security in which hostile component insertion and/or compromised firmware updates can cause supply chain security issues. Another example platform security risk may include confidentiality and integrity risks in which data transfers that are unencrypted may be vulnerable to eavesdropping, stealing, and tampering. Additionally, non-compliant security configuration errors, certificate management, platform security trust, and the like could lead to non-compliance with industry standard security policies. The DMTF SPDM specifications have been developed to alleviate such problems and reduce management overhead in maintaining and establishing the platform security within the IHS infrastructure domain.

The system clock in an IHS (e.g., server, personal computer, laptop computer, tablet PC, set-top box (STB), personal digital assistant (PDA), mobile device, desktop computer, communications device, etc.) can be changed by users with sufficient privileges. Malicious users can also alter the system clock to hide the actual time of an event or force processing to occur that normally occurs at a later date. As such, it would be beneficial to continually monitor the date and time settings of the system clock of an IHS so that changes to the system clock, whether intentional or inadvertent, are quickly detected, and remediation actions taken, such as by notifying administrative personnel or the owner of the IHS that its system clock has been changed to an illicit setting.

Many security functions in IHSs depend on the notion of time. For example, checking the validity of the digital certificates may often include checking for the validity of time in the certificates. Nevertheless, the validity of these checks depend on system time being set properly. Thus, the proper setting of the system time may be an important factor in establishing trust. In many cases, compromising system time can be considered to be an attack vector for security functions, and in particular, those involving the SPDM protocol.

IHSs configured with BMCs often depend upon their respective BMCs to maintain a proper time setting. Nevertheless, maintaining the proper setting of system time in a BMC can be problematic. For example, when a console request the BMC to provide the time configuration settings (e.g., time synchronization at specified intervals from a server (e.g., NIST), there has heretofore been no mechanism to ensure that the time synchronization is performed in the mentioned interval for corroborative evidence. Additionally, the host IHS is often required to set the BMC's time during bootup, but any incorrect time on the Host OS may also impact the time setting on the BMC.

As will be described in detail herein below, embodiments of the present disclosure provide a system and method for improving the trustworthiness of an IHS incorporated with a BMC by attesting the BMC using a device security certificate associated with the BMC, such that, after the BMC is attested for its trustworthiness, request that the attested BMC obtain its system time, sign the obtained system time using the device security certificate used to attest the BMC, and send the signed system time value to the requester (e.g., a console). In some embodiments, the BMC may generate a time block (e.g., data blob) that includes the current system time, info associated with a source (e.g., Network Time Protocol (NTP) server, National Institute of Standards and Technology (NIST) server, host BIOS, etc.) of the most recent synchronization, and last time at which the synchronization was performed. The console may use this information to make a determination as to whether a time change attack vector has occurred so that administrators (e.g., users of the console) may take appropriate remedial actions.

Within this disclosure the configuration of a server refers to a number and type of hardware devices in the IHS as well as the settings for each of those hardware devices and of the server's main components, such as motherboard settings, BIOS settings, and the like. BMCs typically provide means to export a server profile associated with the existing configuration of a server (e.g., IHS). The exported server profile can then be applied to an existing or new target server. Conventionally, the BMC generates a Server Configuration Profile (SCP) that can be used to store the server profile so that it can be exported and/or imported to or from other servers. A drawback of the conventional SCP is that it stores the server profile in a plain text format (i.e., in the clear). Nevertheless, storing the server profile in plain text format presents several problems. For example, user settings including passwords (hash values) are exported in plain text format. Additionally, a low level of confidence in the integrity of the information stored in the server profile may exist because it can be easily modified. That is, the BMC on which these settings are being imported to does not know if the configuration has been tampered with or not. For another example, a user (e.g., Administrator of the server) may be required to apply these settings manually on each of the servers in a clustered environment. Embodiments of the present disclosure provide a solution to these problems, among others, by providing a system and method for cloning BMC profiles in a cluster environment that causes a target server to mutually authenticate with a source IHS, and uses security keys generated according to the mutual authentication process to encrypt the server profile at the source server, and decrypt it at the target server so that the integrity and security of information in the server profile remains intact.

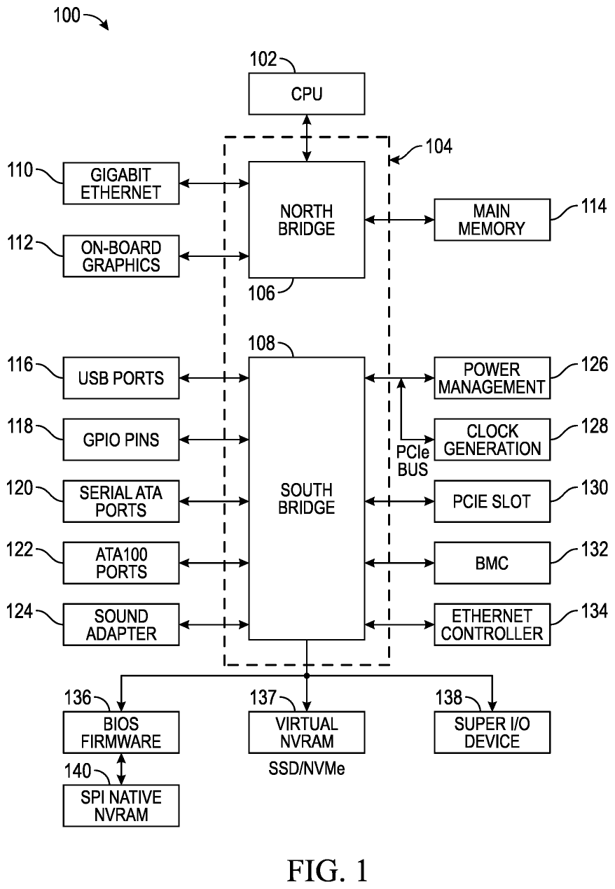

FIG. 1 shows an example of an IHS 100 that may be configured to implement embodiments described herein. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in an embodiment, southbridge 108 may include a serial advanced technology attachment (SATA) adapter for providing one or more serial ATA ports 120 and/or an ATA 100 adapter for providing one or more ATA 100 ports 122. Serial ATA ports 120 and ATA 100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS/firmware 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, etc. Additionally or alternatively, BMC 132 may include one or more firmware volumes, each volume having one or more firmware files used by the BIOS' firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

According to embodiments of the present disclosure, the IHS 100 may support SPDM in which the BMC 132 manages the operation of one or more managed devices configured in the IHS 100. The SPDM specification provides for secure communication between the BMC 132 and the managed devices in the IHS 100. To meet this goal, the SPDM specification facilitates certificate chains that are stored in up to eight slots. Slot 0 is a default slot that is always used, while the other slots (e.g., slots 1-7) may be allocated for use by the administrator of the IHS 100. The SPDM specification also provides a slot mask that identifies each certificate chain.

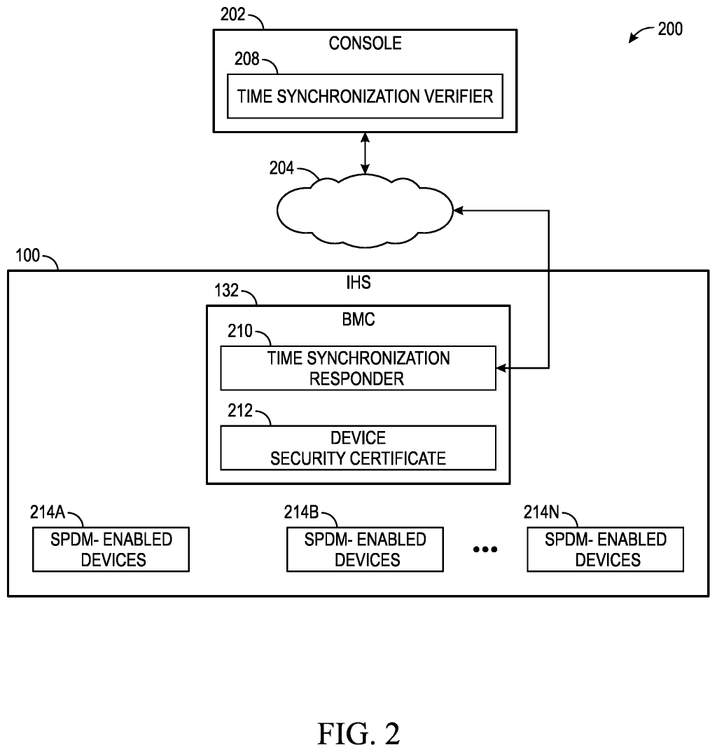

FIG. 2 illustrates an example system time trustworthiness verification system 200 according to one embodiment of the present disclosure. The system time trustworthiness verification system 200 includes a console 202 communicatively coupled to a BMC 132 configured in an IHS 100 over a network 204, which may be any suitable type, such as a local area network (LAN) or a Wide Area Network (WAN) (e.g., the Internet). The console 202 stores and executes a time synchronization verifier 208 that communicates with a time synchronization responder 210 to ensure time synchronization on the BMC 132 has not been corrupted using a device security certificate 212 associated with the BMC 132.

According to embodiments of the present disclosure, the BMC 132 may support SPDM to manage the operation of one or more SPDM-enabled devices 214a-n (collectively 214) configured in the IHS 100. Examples of such SPDM-enabled devices 214a-n include on-board graphics adapter 112, Ethernet adapter 110, USB ports 116, sound adapter 124, Ethernet controller 134, GPIO pins 118, PCIe slot 130, Power management circuitry 126, clock generation circuitry 128, serial ATA ports 120, ATA 100 ports 122, virtual NVRAM 137, SPI native NVRAM 140, and Super I/O device 138 as described herein above. The SPDM specification provides for secure communication between the BMC 132 and the managed devices in the IHS 100. To meet this goal, the SPDM specification facilitates certificate chains that are stored in up to eight slots. Slot 0 is a default slot that is always used, while the other slots (e.g., slots 1-7) may be allocated for use by the administrator of the IHS 100. The SPDM spec also provides a slot mask that identifies each certificate chain. In a particular example, the device security certificate 212 may be a device security certificate stored in slot 0 of the SPDM-enabled BMC 132.

The console 202 may be any type that monitors and controls the operation of the IHS 100. For example, the console 202 may include at least a portion of the Dell EMC OpenManage Enterprise (OME) that is installed on a secure virtual machine (VM), such as a VMWARE Workstation. In general, the console 202 may be used by a user, such as an administrator of the IHS 100, to manage the operation of the IHS 100 via the BMC 132. As mentioned previously, checking the validity of the digital certificates may often include checking for the validity of time in the certificates due to the nature of how SPDM ensures trust in managed devices. Nevertheless, it would be beneficial to ensure that the system time managed by the BMC 132 is not inadvertently or illicitly changed. The time synchronization verifier 208 and time synchronization responder 210 function together to continually monitor the system time setting in the BMC 132 using the trust mechanism established using SPDM so that if the system time of the BMC 132 is set to an illicit value, the user of the console 202 may be alerted in a timely manner so that security exposure to the BMC 132 and its associated IHS 100 may be minimized.

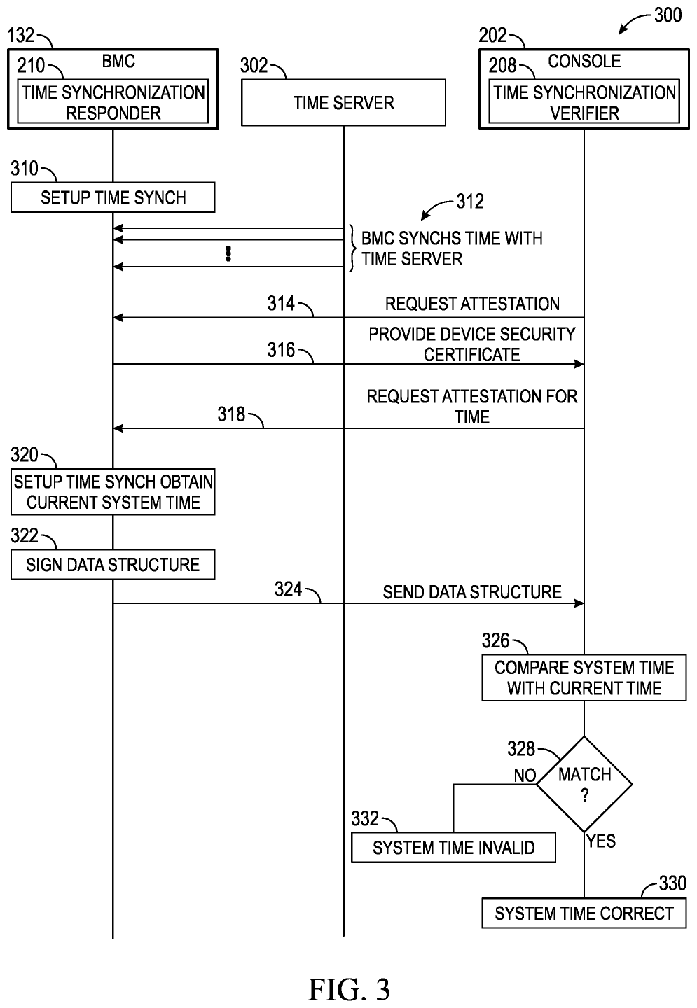

FIG. 3 illustrates an example flow diagram of a system time trustworthiness verification method 300 showing how the time synchronization verifier 208 may communicate with the time synchronization responder 210 to continually monitor the system time of the BMC 132 to ensure that its system time is not changed to an invalid value according to one embodiment of the present disclosure. Additionally or alternatively, the system time trustworthiness verification method 300 may be performed at least in part, by the system time trustworthiness verification system 200 as described herein above with reference to FIG. 2.

Initially at step 310, a time server 302 is set up as time synchronization sources. The time server 302 may include any online source that provides current network time information. One time server 302, for example, may be ‘nist.gov’ website that provides a current date and time upon request. Other online time servers exist and can be used. Thereafter at step 312, the BMC 132 syncs its system time with that of the time server 302. In one embodiment, the BMC 132 syncs its system time with the time server 302 at ongoing intervals, such as periodically (e.g., once an hour, once a day, etc.).

At some later point in time, the time synchronization verifier 208 configured in the console 202 desires to attest the system time in the BMC 132. This point in time can be at any time after the BMC 132 has initially synchronized with the time server 302. Therefore at step 314, the time synchronization verifier 208 requests attestation from the time synchronization responder 210 in which it responds by providing its device security certificate 212 to the time synchronization verifier 208 at step 316. The time synchronization verifier 208 requests attestation for the system time running in the BMC 132 at step 318. In one embodiment, the console 202 is considered to be a requester, while the BMC 132 is considered to be a responder within the meaning and intent of the SPDM specification. In another embodiment, the request is for the time synchronization responder 210 in the BMC 132 to continually send current system time to the time synchronization verifier 208 at regular intervals (e.g., once an hour, once a day, etc.). In other embodiments, the request is for the time synchronization responder 210 to send a single response including the system time to the time synchronization verifier 208. Such cases may be useful when a user, such as the administrator of the IHS 100 is performing diagnostics on the IHS 100 and/or BMC 132 and would like to know the current condition of the system time in real-time.

At the requested time, the time synchronization responder 210 obtains the current system time from the BMC 132 at step 320. In one embodiment, the time synchronization responder 210 obtains information associated with a source (e.g., Network Time Protocol (NTP) server, National Institute of Standards and Technology (NIST) server, host BIOS, etc.) of the most recent synchronization, and last time at which the synchronization was performed, and combines the information with system time in a time block (e.g., data structure). Thereafter at step 322, the time synchronization responder 210 signs the system time and/or data structure including the synchronization time, and synchronization source with its device security certificate 212, and sends it to the time synchronization verifier 208 at step 324.

At step 326, the time synchronization verifier 208 obtains the system time and optional most recent synchronization, and last time at which the synchronization was performed, and compares it against its known values for the system time and optional most recent synchronization, and last time at which the synchronization was performed. For example, the time synchronization verifier 208 may obtain system time from a time server, such as time server 302, and compare the value received from the time synchronization responder 210 to see whether it matches its obtained value. The time synchronization verifier 208 may also compare the optional most recent synchronization, and last time at which the synchronization was performed to determine whether it matches. In one embodiment, the time synchronization verifier 208 may use the optional most recent synchronization, and last time at which the synchronization was performed as diagnostic information to be used for investigating why the system time it received from the time synchronization responder 210 does not match its own received value.

At step 328, If the system time received from the time synchronization responder 210 and its own received system time value matches, processing continues at step 330 in which the BMC 132 and its associated IHS 100 are allowed to operate in a normal manner with no further action taken. If, however, the system time received from the time synchronization responder 210 and its own received system time value does not match, processing continues at step 332 in which the time synchronization verifier 208 generates an alert message to the console 202 that the system time associated with the BMC 132 is deemed to be invalid (e.g., has been tampered with). For example, the console 202 may generate a pop-up window on a monitor screen that includes information about the faulty BMC 132 system time, such a unique identifier (UID) of the IHS 100 associated with the BMC 132 and the nature of the discrepancy.

The time synchronization verifier 208 may perform any suitable remedial actions if and when the system time of the BMC 132 has been deemed to be invalid. For example, the time synchronization verifier 208 may generate instructions disabling or at least partially disabling operation of the IHS 100 associated with the BMC 132 when its system time is deemed to be invalid. For another example, the time synchronization verifier 208 may generate instructions for placing the IHS 100 in a failsafe mode of operation, and prompt personnel to investigate the source of the invalid system time, and cure any security breaches that may have been generated thereby.

While the steps described above were directed to improving a system time trustworthiness of a single BMC 132, it should be appreciated that the system time trustworthiness verification method 300 may be concurrently performed by the time synchronization verifier 208 on multiple time synchronization responder 210s configured on each BMC 132 of multiple IHSs 100, such as multiple servers configured in a data center or cluster. Nevertheless, when use of the system time trustworthiness verification method 300 is no longer needed or desired, the system time trustworthiness verification method 300 ends.

Although FIG. 3 describes an example method 300 that may be performed to improve the trustworthiness of the system time maintained by a SPDM-enabled BMC 132, the features of the method 300 may be embodied in other specific forms without deviating from the spirit and scope of the present disclosure. For example, the method 300 may perform additional, fewer, or different operations than those described above. For another example, the method 300 may be performed in a sequence of steps different from that described above. As yet another example, certain steps of the method 300 may be performed by other components than those described above, such as by the BIOS configured in the IHS 100.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a Baseboard Management Controller (BMC) conforming to a Security Protocol and Data Model (SPDM) specification, wherein the BMC comprises at least one memory coupled to at least one processor, the at least one memory having program instructions stored thereon that, upon execution by the at least one processor, cause the BMC to:
after being attested by a requester using a device security certificate associated with the BMC, obtain a system time value stored in the BMC;
sign the system time value using the device security certificate; and
send the signed system time value to the requester.

2. The IHS of claim 1, wherein the program instructions, upon execution, further cause the BMC to:
obtain information associated with a source of the most recent synchronization, and a last time at which the synchronization was performed;
combine the information with the system time value in a data structure; and
sign the data structure using the device security certificate; and
send the data structure to the requester.

3. The IHS of claim 1, wherein the program instructions, upon execution, further cause the BMC to perform the acts of obtaining a system time value, signing the system time value, and sending the signed system time value at ongoing intervals.

4. The IHS of claim 1, wherein the program instructions, upon execution, further cause the BMC to perform the acts of obtaining a system time value, signing the system time value, and sending the signed system time value in response to a request from the requester.

5. The IHS of claim 1, wherein the requester comprises a console.

6. The IHS of claim 5, wherein the console comprises program instructions, that upon execution, cause the console to:
upon receiving the data structure, determine whether the system time value is invalid; and
generate an alert message based on the determination.

7. The IHS of claim 6, wherein the program instructions, upon execution, further cause the console to generate instructions for inhibiting operation of the IHS based on the determination.

8. The IHS of claim 1, wherein the device security certificate comprises a device identity certificate conforming to the SPDM specification.

9. The IHS of claim 1, wherein the program instructions, upon execution, further cause the BMC to obtain the system time value at ongoing intervals.

10. A system time trustworthiness verification method comprising:
after being attested by a requester using a device security certificate associated with a Baseboard Management Controller (BMC), obtaining a system time value stored in the BMC, wherein the BMC conforms to a Security Protocol and Data Model (SPDM) specification;
signing the system time value using the device security certificate; and
sending the signed system time value to the requester.

11. The system time trustworthiness verification method of claim 10, further comprising:
obtaining information associated with a source of the most recent synchronization, and a last time at which the synchronization was performed;
combining the information with the system time value in a data structure; and
signing the data structure using the device security certificate; and
sending the data structure to the requester.

12. The system time trustworthiness verification method of claim 10, further comprising performing the acts of obtaining a system time value, signing the system time value, and sending the signed system time value at ongoing intervals.

13. The system time trustworthiness verification method of claim 10, further comprising performing the acts of obtaining a system time value, signing the system time value, and sending the signed system time value in response to a request from the requester.

14. The system time trustworthiness verification method of claim 10, further comprising:
determining, using a console, whether the system time value is invalid upon receiving the data structure; and
generating, using the console, an alert message based on the determination.

15. The system time trustworthiness verification method of claim 14, further comprising generating, by the console, instructions for inhibiting operation of an Information Handling System (IHS) based on the determination.

16. The system time trustworthiness verification method of claim 10, wherein the device security certificate comprises a device identity certificate conforming to the SPDM specification.

17. The system time trustworthiness verification method of claim 10, further comprising obtaining the system time value at ongoing intervals.

18. A computer program product comprising a computer readable storage medium having program instructions stored thereon that, upon execution by a Baseboard Management Controller (BMC), cause the BMC to:
after being attested by a requester using a device security certificate associated with the BMC, obtain a system time value stored in the BMC;
sign the system time value using the device security certificate; and
send the signed system time value to the requester.

19. The computer program product of claim 18, wherein the program instructions, upon execution, further cause the BMC to:
obtain information associated with a source of the most recent synchronization, and a last time at which the synchronization was performed;
combine the information with the system time value in a data structure; and
sign the data structure using the device security certificate; and
send the data structure to the requester.

20. The computer program product of claim 18, wherein the console comprises program instructions, upon execution, cause a console to:
upon receiving the data structure, determine whether the system time value is invalid, wherein the requester comprises the console; and
generate an alert message based on the determination.
